(19) United States
(12) Patent Application Publication
(10) Pub. No.: US 2008/0117151 A1
(43) Pub. Date: May 22, 2008

(54) Reflectors for display pixels

(75) Inventors: Juha Nurmi, Salo (FI); Kaj Saarinen, Turku (FI); Ilkka Antero Hyytiainen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/594,030

(22) Filed: Nov. 6, 2006

(51) Int. Cl. G09G 3/36

(52) U.S. Cl. 345/88

(57) ABSTRACT

An apparatus comprises an arrangement of display pixels and reflectors arranged to reflect ambient light passing through the display pixels. The reflectors are electrically controllable, in order to enable an optimization of the portion of the ambient light that is reflected by the reflectors. A required adjustment of such electrically controllable reflectors can be determined, and the reflectors can then be controlled accordingly.

### FIELD OF THE INVENTION

The invention relates to reflectors for display pixels.

### BACKGROUND OF THE INVENTION

Some displays, like liquid crystal displays (LCD), employ an array of display pixels, which do not emit any light themselves, but which allow a suitable amount of light to pass for producing a desired image.

For colored images, the display pixels may further be divided into a plurality of sub-pixels. A different color filter can then be associated to each of the separately controllable sub-pixels.

If the display uses a transmissive filter construction, a backlight source is arranged behind the display pixels and provides the light that passes through the display pixels or sub-pixels.

If the display uses a reflective filter construction, reflectors are arranged behind the display pixels. Ambient light reaches the reflectors via the display pixels, and the reflectors reflect the light back through the display pixels.

If the display uses a transflective filter construction, transmission of backlight and reflection of ambient light are used in parallel.

### SUMMARY

The invention proceeds from the consideration that if a display comprises fixed reflective characteristics, the tuning to find the optimal reflective characteristics during research and development is very time consuming. Moreover, the selected reflective characteristics can only be a compromise for various ambient light conditions.

An apparatus is proposed, which comprises an arrangement of display pixels and electrically controllable reflectors arranged to reflect ambient light passing through said display pixels.

Such an apparatus could be for instance a display module, a more comprehensive entity of an electronic device, or an electronic device as a whole.

Moreover, an electronic device is proposed, which comprises such an apparatus and in addition a user interface. The electronic device could be for instance a mobile terminal, a personal digital assistant (PDA), a notebook, or any other device that enables a presentation of an image.

Moreover, a method is proposed, which comprises determining a required adjustment of electrically controllable reflectors, the reflectors being arranged to reflect ambient light passing through display pixels. The method further comprises controlling the reflectors accordingly.

Finally, a computer program product is proposed, in which a program code is stored in a computer readable medium. When executed by a processor, the program code determines a required adjustment of electrically controllable reflectors, which reflectors are arranged to reflect ambient light passing through display pixels, and causes a corresponding control of the reflectors.

The computer program product could be for example a separate memory device, or a memory that is to be integrated in an electronic device.

The invention is to be understood to cover such a computer program code also independently from a computer program product and a computer readable medium.

By employing electrically controllable reflectors instead of reflectors with fixed reflection characteristics, the portion of the ambient light falling onto the display pixels that is actually reflected and thus contributes to a presentation can be adjusted.

The invention thus provides a possibility of adjusting the exploitation of ambient light based on current needs, for instance based on the current intensity of ambient light or based on user preferences.

The reflectors could be electrically controllable in that they comprise an effective reflective area, the size of which is electrically controllable. Alternatively, the reflection capability of the reflectors could be electrically controllable. They could be configured, for example, to gradually change from being entirely reflective to entirely transmissive based on an applied control voltage or current.

The electrically controllable reflectors can further be implemented in various ways. The reflectors could comprise for instance electrically controllable mirrors, like Microelectromechanical Systems (MEMS) based mirrors, which are also referred to as Micro Systems Technology (MST) based mirrors. Alternatively, the reflectors could comprise an electrically controllable liquid or an electrically controllable substrate.

Moreover, a control component may be provided, which is configured to electrically control the reflectors by applying a suitable voltage or current.

An evaluation component could further be arranged to receive an indication of an intensity of ambient light from a light sensor. The evaluation component could then be configured to cause the control component to electrically control the reflectors depending on the indication of an intensity of ambient light. The control could be configured for instance such that the higher the indicated intensity of ambient light, the higher the portion of the ambient light that is reflected by the reflectors, either due to an increased effective reflective area of the reflectors or due to an increased reflectivity of a constant effective reflective area.

To this end, the proposed apparatus could comprise or be connected to a light sensor, which is arranged to detect an intensity of ambient light.

Alternatively or in addition, an evaluation component could be arranged to receive information on a user input. The evaluation component could then be configured to cause the control component to electrically control the reflectors depending on the information on a user input.

The invention may be used for example for adjusting the relation between transmissive and reflective characteristics of a display.

A backlight source could be configured to provide a backlight for transmission in direction of the display pixels. In this case, adjusting the reflector means at the same time adjusting the ratio between the reflected ambient light and the backlight passing the display pixels.

The adjustment of the reflectors could be moreover such that with a decreasing amount of reflected ambient light, an increasing amount of backlight is allowed to pass the display pixels. When a larger fraction of the emitted backlight is allowed to pass the display pixels, the current consumption for the backlight will be reduced.

It is to be understood that the backlight source could equally be electrically controllable.

In case the apparatus is to be employed for presenting colored images, it might further comprise color filters arranged to color filter the light passing through the display pixels. The color filters could be arranged on either side of the display pixels.

It is to be understood that all presented exemplary embodiments may also be used in any suitable combination.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic top view on a purely transmissive or purely reflective filter arrangement;

FIG. 2 is a schematic top view on a transflective filter arrangement with fixed reflective areas;

FIG. 3 is a schematic side view on a transflective filter arrangement with fixed reflective areas;

FIG. 4 is a schematic block diagram of a first exemplary electronic device, which has a display using a transflective filter arrangement with variable reflective areas;

FIG. 5 is a flow chart illustrating an operation in the device of FIG. 4;

FIG. 6 is a schematic block diagram of a second exemplary electronic device, which has a display using a transflective filter arrangement with variable reflective areas;

FIG. 7 are schematic diagrams illustrating a first exemplary implementation of an adjustable reflector; and

FIG. 8 are schematic diagrams illustrating a second exemplary implementation of an adjustable reflector.

### DETAILED DESCRIPTION

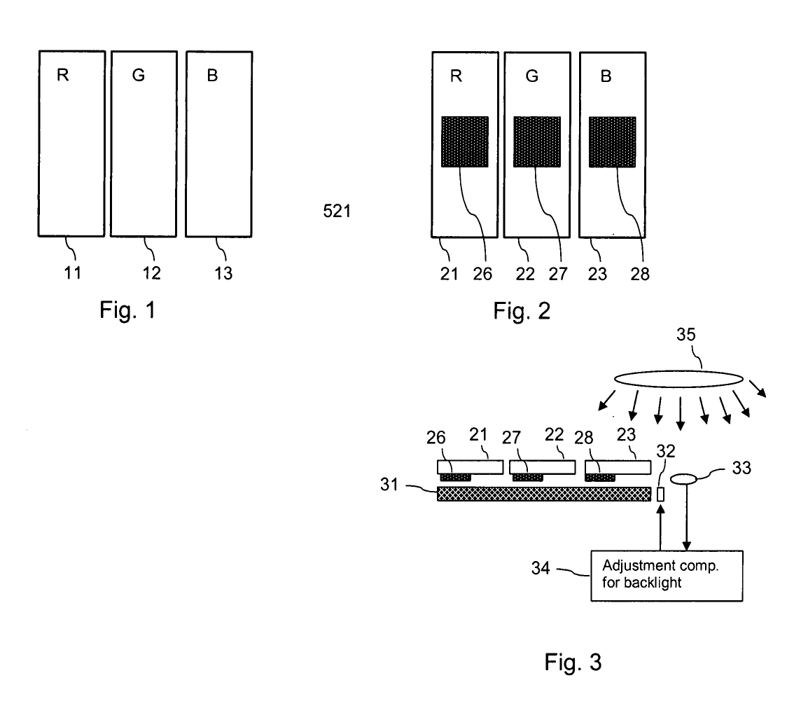

To illustrate the difference of variable filter constructions in accordance with the invention to fixed filter constructions, FIGS. 1 to 3 present at first some fixed filter constructions. These fixed filter constructions may be employed for a display, which is composed of a plurality of pixels, each pixel comprising a respective sub-pixel for different colors.

In the case of a transmissive or a reflective filter construction, the filter construction is uniform over an entire pixel or sub-pixel area. FIG. 1 is a top view on such a transmissive or reflective filter construction for one pixel of a display.

For a transmissive filter construction, a backlight source is arranged behind three sub-pixels for red (R), green (G) and blue (B). A corresponding color filter 11, 12, 13 is arranged in front of each of the sub-pixels covering the entire area of the respective sub-pixel. The light emitted by the backlight source passes through the sub-pixels, which control the amount of light that is to pass for a current presentation, and the passed light is then color filtered by the color filters 11, 12, 13.

For a reflective filter construction, a reflector is arranged behind sub-pixels for red (R), green (G) and blue (B). A corresponding color filter is arranged in front of each of the sub-pixels. Both reflector and color filter cover the entire area of the respective sub-pixel. As they are thus congruent, reference signs 11, 12, 13 can be considered to refer to both of them in FIG. 1. Ambient light passes via the color filters and the sub-pixels to the reflectors, which reflect the light back through the sub-pixels and the color filters. The sub-pixels control again the amount of light that is to be passed in both directions for a current presentation.

In the case of a transflective filter construction, a color filter arranged in front of a sub-pixel may cover again the entire area of this sub-pixel, while a respective reflector having a smaller area is arranged behind the sub-pixels.

FIG. 2 is a top view on such a transflective filter construction for one pixel of a display. Transmissive color filters 21, 22, 23 for red (R), green (G) and blue (B) are arranged in front of each of the sub-pixels, covering the entire area of the respective sub-pixel. A reflector 26, 27, 28 having an area, which is considerably smaller than the sub-pixel area, is arranged behind each of the sub-pixels.

FIG. 3 is a schematic side view on such a fixed transflective filter construction for one pixel including sub-pixels for red, green and blue.

FIG. 3 presents three transmissive color filters for red (R) 21, green (G) 22 and blue (B) 23. Below each of these color filters 21, 22, 23, a smaller reflector 26, 27, 28 is shown. Below the reflectors 26, 27, 28, a light guide 31 is arranged. The light guide 31 is fed by a backlight source 32. Further, an ambient light sensor 33 is provided, which is linked to an adjustment component 34 for the backlight source 32. The sub-pixels themselves are not shown explicitly. They may be considered to be integrated in a respective single unit with the color filters 21, 22, 23, for instance on the side facing the reflectors 26, 27, 28.

Ambient light, provided by some ambient light source 35, passes through the color filters 21, 22, 23 and the sub-pixels and fall onto either a reflector 26, 27, 28 or the light guide 31. Ambient light falling onto a reflector 26, 27, 28 is reflected to contribute to a current presentation. Ambient light falling onto the light guide 31 does not contribute to the presentation. Light emitted by the light guide 31 and falling onto one of the reflectors is reflected back to the light guide 31, where it can be partly recycled. The amount of light that is actually lost depends on the efficiency of the recycling. Light emitted by the light guide 31 in the direction of the area of a color filter 21, 22, 23, which is not shielded by a reflector 26, 27, 28, passes through the color filter 21, 22, 23 to contribute to a current presentation.

The ambient light sensor 33 measures the intensity of incident light from an ambient light source 35. An indication of the current intensity is passed on the to adjustment component 34. The adjustment component 34 adjusts the intensity of light, which is emitted by the backlight source 32 into the light guide 31, according to the intensity of the ambient light. That is, the higher the detected intensity of incident ambient light, the higher the intensity of the light that is emitted by the backlight source 32.

The transflective filter construction thus comprises both transmissive and reflective areas but the ratio of these areas is fixed, once the filter construction has been designed and manufactured. That is, it is physically impossible to change the ratio of the manufactured filter construction. This implies as well that with a given backlight intensity and a given ambient light intensity, the ratio between the transmitted light and the reflected light cannot be changed.

Moreover, the current consumption of the backlight source 32 cannot be optimized with fixed reflector areas, since the adjustment only has an effect on the transmissive part of the filter construction. That is, when the intensity of light emitted by the backlight source 32 is increased, the amount of lost light is automatically increased by the same percentage.

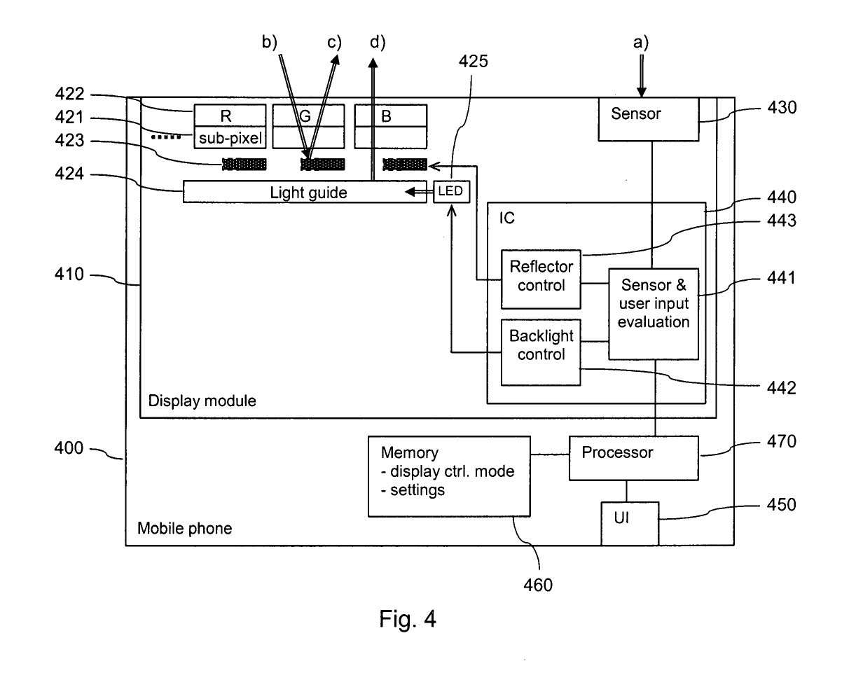

FIG. 4 is a schematic block diagram of a first exemplary electronic device 400 in which a flexible transflective filter construction is implemented in accordance with an embodiment of the invention. The device can be for instance a mobile phone.

The mobile phone 400 comprises a display module 410, a user interface 450, including for instance a keypad, a memory 460 and a processor 470 linking the user interface 450 and the memory 460 to the display module 410.

The display module comprises an array of display pixels, for instance pixels of an LCD. Of the array of pixels, only a single pixel is represented. Each pixel includes three sub-pixels 421.

Coplanar to one of the sub-pixels, on the side facing a user of the mobile phone 400, a red (R) color filter is arranged. Coplanar to another one of the sub-pixels, on the side facing a user of the mobile phone 400, a green (G) color filter is arranged. Coplanar to yet another one of the sub-pixels, on the side facing a user of the mobile phone 400, a blue (B) color filter is arranged. In FIG. 4, reference sign 421 is used in common for all sub-pixels, while reference sign 422 is used in common for all color filters. Each of the color filters 422 covers the same area as the sub-pixel 421 to which it is associated.

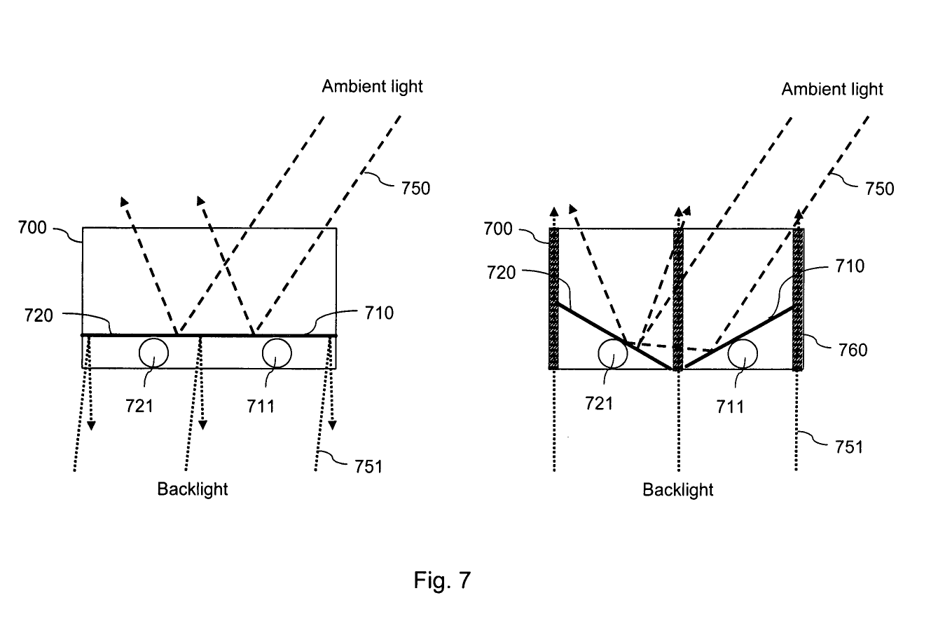

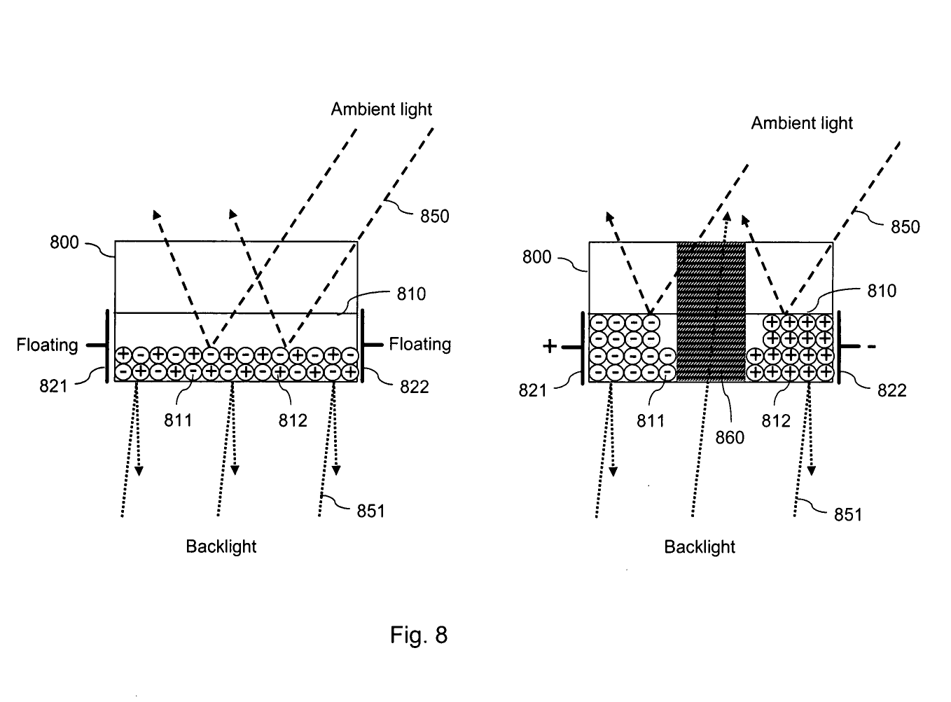

On the opposite side of each sub-pixel 421 and coplanar to the respective sub-pixel 421, a reflector is arranged. Reference sign 423 is used in common for all reflectors. The effective area of the reflectors 423 can be controlled electrically by applying a control voltage. Each of the reflectors 423 is therefore represented by a combination of a rectangle with solid lines, representing a minimum effective area of the reflector 423, and an adjacent rectangle with dashed lines, representing the variability of the effective reflector area. The maximum effective area is at the most equal to the area of the associated sub-pixel 421. The reflectors 423 can be implemented for instance with MEMS based mirrors. Two exemplary implementations of the reflectors 423 will be described further below with reference to FIGS. 7 and 8.

Optionally, the reflector 423 for each sub-pixel 421 may also be adjusted independently. This would enable a white point adjustment in different lighting conditions. Typically, the light spectrum is different in different environments, like home, office, outdoors, etc. An independent adjustment would thus allow an adjustment to the current light spectrum at the same time.

On the side of the reflectors 423 facing away from the sub-pixels 421, a light guide 424 is arranged. The light guide 424 can be employed in common for the entire pixel, for a plurality of pixels or even for all pixels of the display. A backlight source 425, for example an LED or a set of LEDs, is arranged at one end of the light guide 424.

The display module 410 further comprises at least one light sensor 430, which is arranged to detect the intensity of ambient light. When arranging this sensor 430 at the same surface of the mobile phone 400 as the display, the detected intensity will be very similar to the intensity of ambient light falling onto the color filters 422.

The display module 410 further comprises a chip 440, which may be an integrated circuit (IC). The sensor 430 is linked to the IC 440. The IC 440 comprises a circuitry including an evaluation component 441, a backlight control component 442 and a reflector control component 443.

It is to be understood that the mobile phone 400 comprises in addition numerous other components not shown.

The light sensor 430 is arranged to detect the intensity of ambient light, indicated with an arrow a), and to provide a corresponding indication to the evaluation component 441 of the IC 440.

The processor 470 is configured to detect a user input via the user interface 450. If this user input is related to the backlight intensity, the processor 470 forwards the input to the evaluation component 441 of the IC 440 and stores it in parallel in the memory 460. The processor 470 is further configured to provide information stored in the memory 460 to the evaluation component 441 of the IC 440.

The backlight source 425 emits light with an intensity that is controlled by the backlight control component 442 of the IC 440. The reflector control component 443 of the IC 440 controls the size of the effective area of the reflectors 423.

The backlight and reflector control may be the same for all pixels of the display. It is to be understood, however, that the effective area of reflectors 423 that are associated to different types of color filters 422 may be different. Further, in particular in case of a plurality of distributed light sensors, the size of the effective areas of the reflectors 423 may also vary between different pixels, for example between pixels in different portions of the display. Similarly, the intensity of emitted backlight may vary between different pixels or between different portions of the display.

Ambient light passing through one of the color filters 422 and the associated sub-pixel 421 and falling onto the currently effective area of the associated reflector 423, as indicated by arrow b), will be reflected by the reflector 423 back through the sub-pixel 421 and the color filter 422, as indicated by arrow c). The reflected light contributes with the color of the respective color filter 422 and with an intensity controlled by the respective sub-pixel 421 to the currently required presentation. Ambient light passing through one of the color filters 422 and the associated sub-pixel 421 and not falling onto the currently effective area of the associated reflector 423 is not reflected and does not contribute to the presentation.

The light emitted by the backlight source 425 is fed into to the light guide 424, which outputs the distributed light in direction of the sub-pixels 421. Light from the light guide 424 falling onto the effective area of one of the reflectors 423 is blocked and does not contribute to the current presentation. Light from the light guide 424 reaching one of the sub-pixels 421 passes this sub-pixel 421 and the associated color filter 422, as indicated with arrow d). The transmitted light contributes with the color of the light filter 422 and with an intensity controlled by the sub-pixel 421 to the current presentation.

Thus, the area of the color filter construction comprising an effective area of the reflector 423 can be considered as a reflective part of the color filter construction, while the area of the color filter construction not comprising an effective area of the reflector 423 can be considered as a transmissive part of the color filter construction.

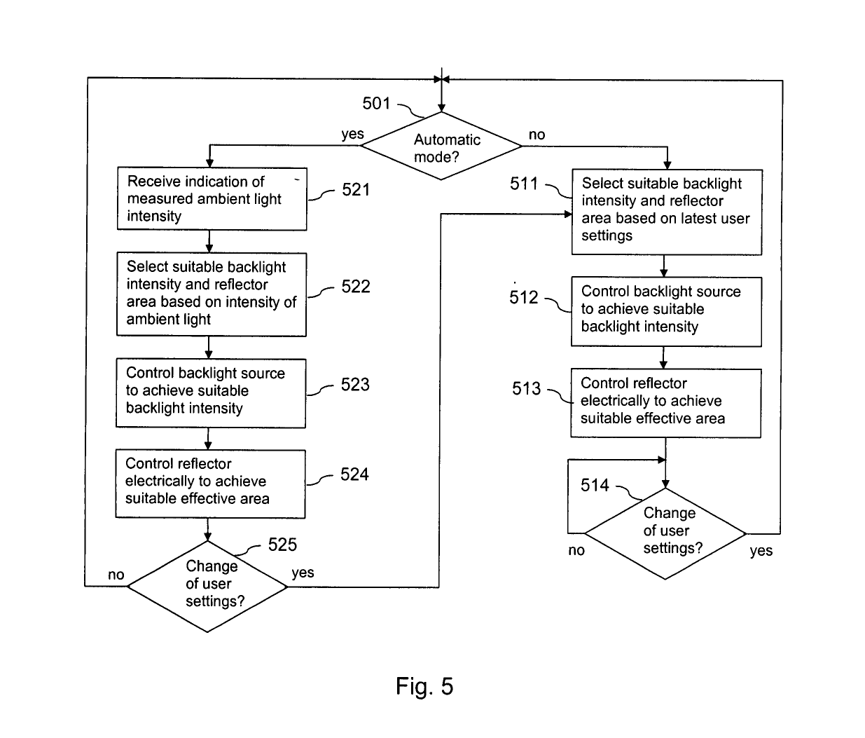

A brightness control operation in the mobile phone 400 will now be described with reference to FIG. 5. FIG. 5 is a flow chart illustrating more specifically the operation of the IC 440.

When the display of the mobile phone 400 is to be activated, the evaluation component 441 first checks whether an automatic mode of the brightness control had been deactivated by a user (step 501). The current brightness control mode can be stored, for instance, in the memory 460. The memory 460 may store as well the latest user settings for a desired backlight intensity. When activating the display, the processor 470 may then provide an indication of the current brightness control mode to the evaluation component 411 and in addition, in case the automatic mode is deactivated, the stored settings.

If the brightness control mode is not the automatic mode (step 501), the evaluation component 441 evaluates the received user settings and determines a suitable backlight intensity and reflector area (step 511).

The user settings could be for instance one of ‘strong’, ‘medium’ or ‘weak’ backlight.

In case the user setting is ‘strong backlight’, the evaluation component 441 selects a high backlight intensity. In addition, it selects small effective reflector areas so that a large percentage of the backlight emitted by the light guide 424 will pass the sub-pixels 421 and the color filters 422.

In case the user setting is ‘medium backlight’, the evaluation component 441 selects a medium backlight intensity. In addition, it selects medium effective reflector areas so that a medium percentage of the backlight emitted by the light guide 424 will pass the sub-pixels 421 and the color filters 422.

In case the user setting is ‘weak backlight’, the evaluation component 411 selects a low backlight intensity. In addition, it selects large effective reflector areas so that a small percentage of the backlight emitted by the light guide 424 will pass the sub-pixels 421 and the color filters 422. Instead, a high percentage of the ambient light will be reflected at the large effective reflector area.

The evaluation component 441 passes an indication of the determined backlight intensity to the backlight control component 442, which controls the backlight source 425 accordingly, for example by feeding a corresponding high, medium or low current to an LED or LEDs forming the backlight source 425 (step 512).

The evaluation component 441 further passes an indication of the determined size of the effective reflector area to the reflector control component 443, which controls the effective area of the reflectors 423 accordingly, for example by applying a corresponding control voltage to MEMS based mirrors that are used for forming the reflectors 423 (step 513).

Thereafter, the evaluation component 441 monitors whether the processor 470 provides information about any change of user settings (step 514).

A user of the mobile phone 400 may change the settings via the user interface 450. The user may activate on the one hand the automatic mode. On the other hand, the user may change the previously selected backlight intensity. Such a user input is performed under control of the processor 470. The processor 470 updates the entries in the memory 460 accordingly and informs the evaluation component 441.

Upon receipt of such information on a new user input (step 514), the evaluation component 441 determines the type of the user input.

If the evaluation component determines that the automatic mode remains deactivated (step 501), steps 511 to 514 are repeated based on the new desired backlight intensity.

If the evaluation component 441 detects in contrast that an automatic mode is set when the display is to be activated or that the user deactivated the automatic mode later on (step 501), the evaluation component 441 checks an indication of the current ambient light intensity that is received from the light sensor 430 (step 521).

The evaluation component 441 evaluates the current ambient light intensity and determines a suitable backlight intensity and a suitable reflector area (step 522).

In the case of an ambient light having a low intensity, the evaluation component 441 selects a high backlight intensity. In addition, it selects small effective reflector areas so that a large percentage of the backlight emitted by the light guide 424 will pass the sub-pixels 421 and the color filters 422.

In the case of an ambient light having a high intensity, the evaluation component 441 selects a low backlight intensity. In addition, it selects large effective reflector areas so that a small percentage of the backlight emitted by the light guide 424 will pass the sub-pixels 421 and the color filters 422. Instead, a high percentage of the ambient light will be reflected.

In between a lowest considered intensity and a highest considered intensity of the ambient light, the backlight intensity and effective reflector areas can be adjusted continuously or in steps.

As in step 512, the evaluation component 441 now passes an indication of the determined backlight intensity to the backlight control component 442, which controls the backlight source 425 accordingly, for instance by feeding a corresponding high, medium or low current to an LED or LEDs forming the backlight source 425 (step 523).

As in step 513, the evaluation component 441 further passes an indication of the determined size of the effective reflector area to the reflector control component 443, which controls the effective area of the reflectors 423 accordingly, for instance by applying a corresponding control voltage to MEMS based mirrors that are used for forming the reflectors 423 (step 524).

Subsequently, the evaluation component 441 monitors whether the processor 470 provides information about a change of user settings (step 525).

As long as no change of user settings is indicated by the processor 470, steps 521 to 525 are repeated in a loop.

In case a change of user settings is indicated by the processor 470, this implies that the automatic mode has been deactivated and that an indication of a new desired backlight intensity is provided. The evaluation component 441 may thus continue directly with step 511.

The reflector control component 443 could be configured in addition to take care of a white point adjustment when controlling the reflectors 423. The evaluation component 441 could be configured to this end to evaluate the current light spectrum based on the information received from the sensor 430 and to provide the reflector control component 443 with corresponding instructions.

It is to be understood that the implementation of the invention can be varied in many ways. For example, it could be implemented in various other devices than mobile phones. Further, the reflectors could be realized for instance by electrically controllable liquids or substrates, instead of by MEMS based mirrors. Moreover, it would be possible to vary reflectivity and transmissivity of an entire reflector instead of varying its effective area. In addition, the control of the backlight and the reflectors does not have to be implemented on a chip. It could equally be performed, for example, by a processor executing corresponding software. Further, the control of backlight and reflectors does not have to be integrated into the display module itself, etc.

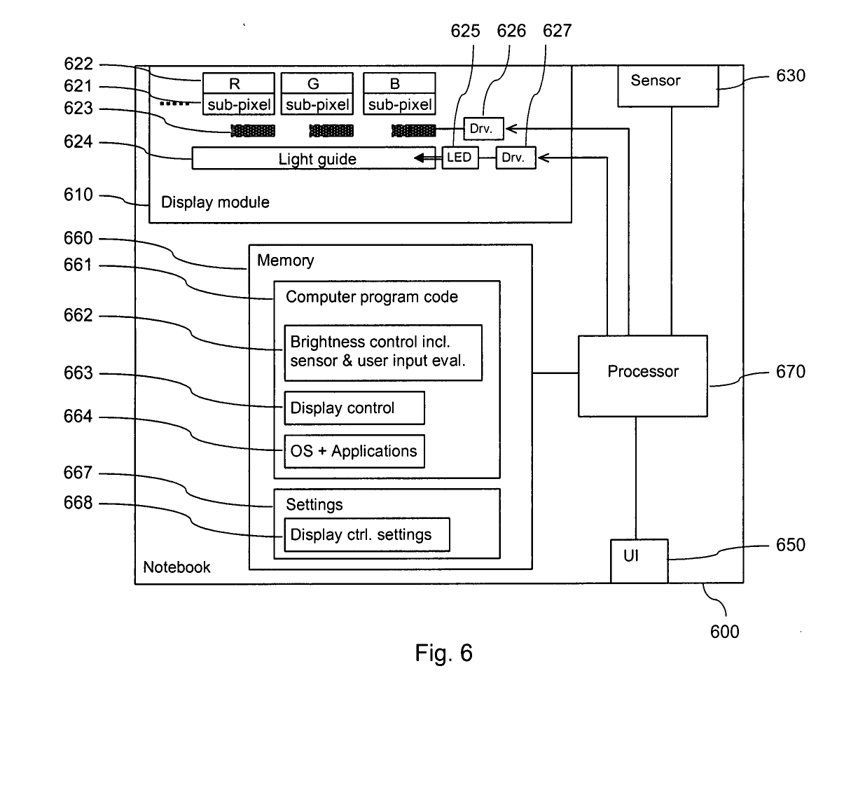

FIG. 6 is a schematic block diagram of a second exemplary electronic device 600, in which a control of a flexible transflective filter construction is implemented in software. The device can be for instance a notebook.

The notebook 600 comprises a processor 670 and, connected to this processor 670, a display module 610, a memory 660, a user interface 650 and a light sensor 630.

The display module comprises again an array of sub-pixels 621 with associated color filters 622 and reflectors 623. The arrangement of these components can be the same as described with reference to FIG. 4. The reflectors 623 can be realized for example by a fixed reflective portion, indicted by a rectangle with solid lines, and one or more adjacent portions of an embedded liquid or a substrate, indicated by dashed lines, which can change its state from transmissive to reflective and vice versa depending on an applied voltage. A driver 626 is arranged for providing the required control voltages to the reflectors 623.

On the side of the reflectors facing away from the sub-pixels, again a light guide 624 is arranged. A backlight source 625, for example an LED, is arranged at one end of the light guide 624. A driver 627 is arranged for providing a controlled current to the backlight source 625.

The light sensor 630 is arranged to detect the intensity of ambient light. Again, when arranging this sensor 630 at the same surface of the notebook 600 as the color filters 622, the detected light intensity can be very similar to the intensity of ambient light falling onto the color filters 622.

The processor 670 is configured to execute implemented computer program code, which it may retrieve from the memory 660.

The memory 660 comprises to this end a section for storing computer program code 661. The implemented code includes a brightness control code 662 designed for evaluating the intensity of ambient light indicated by the sensor 630 and a backlight related user input via the user interface 650, and for generating corresponding commands for the backlight source driver 627 and the reflector driver 626. The implemented code further includes operating system and application code 664. The implemented code further includes a display control code 663 designed for adjusting the amount of light that is allowed to pass the sub-pixels in accordance with an image that is currently to be presented by the operating system or some application to a user.

The memory 660 comprises in addition a settings section 667 storing display control settings 668, similar as memory 460 of FIG. 4. The stored display control settings 668 may thus include for example a current brightness control mode and the latest user settings for a desired backlight intensity, etc.

It is to be understood that the notebook comprises in addition numerous other components not shown.

When an image, defined by the operating system or by a currently executed application, is to be presented to a user of the notebook 600, the processor 670 may control the amount of light that is allowed to pass the sub-pixels 621 accordingly in a conventional manner making use of the display control code 663.

In addition, the processor 670 realizes the same functions as the evaluation component 441 of FIG. 4, described with reference to FIG. 5. Further, the processor 670 causes the drivers 627, 626 to perform the same functions as the backlight control component 442 and the reflector control component 443, respectively, of FIG. 4, described with reference to FIG. 5. The processor 670 receives to this end user input via the user interface 650 and, in addition, the measurement results form the light sensor 630. Further, the processor 670 updates the display control settings 668 in the memory 660 and retrieves the current display control settings 668 whenever required.

It becomes apparent that both presented embodiments allow optimizing the relation between the parts of the sub-pixels that are associated to a transmissive area passing backlight and a reflective area reflecting ambient light for any ambient light condition or according to user preferences. Further, the current consumption is reduced, as less power is lost with a backlight having a high intensity, when the transmissive area is increased at the same time.

The functions illustrated by the sub-pixels 421, 621 can be viewed as first means for allowing a controllable amount of light passing through them. The functions illustrated by the reflectors 423, 623 can be viewed as second means for reflecting ambient light passing through the first means, wherein the second means are electrically controllable. The functions illustrated by the evaluation component 441 or by the processor 670 executing computer program code 662 can be viewed as third means for determining a required adjustment of the second means. The functions illustrated by the reflector control component 443 or the reflector driver 626 can be viewed as fourth means for controlling the second means accordingly. The functions illustrated by backlight source 425 and backlight guide 424 or backlight source 625 and backlight guide 624 can be viewed as fifth means for providing a backlight for transmission in direction of the first means.

FIGS. 7 and 8, finally, are schematic diagrams illustrating two exemplary implementations of adjustable reflectors 423, 623 that could be employed in the electronic device 400 or the electronic device 600.

FIG. 7 presents on the left hand side and on the right hand side the same part of a display 700 in different situations. The display 700 comprises as reflectors a plurality of MEMS based mirrors 710, 720, two of which are presented. Beneath each mirror 710, 720, a control electrode 711, 721 is arranged. A separate control electrode 711, 721 could be employed for each mirror 710, 720. Alternatively, a respective control electrode 711, 721 could be employed for a plurality of mirrors 710, 720. Adjacent mirrors 710, 720 are associated alternately to a first set of mirrors 710 and a second set of mirrors 720.

In a situation presented on the left hand side, no control voltage is applied to the control electrodes 711, 721. The mirrors 710, 720 are arranged side by side with horizontally arranged surfaces and basically without gaps between them. As a result, all ambient light 750 entering the display 700 is reflected by the front surface of the mirrors 710, 720. Any emitted backlight 751 is reflected by the rear surface of the mirrors 710, 720, for example back to a light guide, and does thus not contribute to a presentation.

In the situation presented on the right hand side, a first voltage is applied to the electrodes 711 that are associated to the mirrors 710 of a first set, while a second, opposite voltage is applied to the electrodes 721 that are associated to the mirrors 720 of a first set. As a result, the mirrors 710 of the first set and the mirrors 720 of the second set are tilted in opposite directions. Due to the tilting, gaps are opened between the mirrors 710, 720, which allow a part of the emitted backlight 751 to pass and to contribute to a presentation. The areas 760 of the display 700, which are now traversed by backlight as well, are pointed out by hatching. A portion of the ambient light 750, in turn, is not reflected anymore by the mirrors 710, 720, but passes through the gaps and does thus not contribute to the presentation anymore.

FIG. 8 presents on the left hand side and on the right hand side the same part of another display 800 in different situations. The display 800 comprises as a reflector an encased liquid 810 with charged particles having a reflective surface. Some of the particles 811 are charged negatively, while the other particles 812 are charged positively. A respective electrode 821, 822 is attached to the left side and the right side of the encased liquid 810.

In a situation presented on the left hand side, a floating signal is applied to the electrodes 821, 822. As a result, the charged particles 811, 812 are evenly distributed in the casing. Due to the reflective surface of the particles 811, 812, all ambient light 850 entering the display 800 is reflected by the current front surface of the particles 811, 812. Any emitted backlight 851 is reflected by the current rear surface of the particles 811, 812, for example back to a light guide, and does thus not contribute to a presentation.

In the situation presented on the right hand side, a positive voltage is applied to the left electrode 821, while a negative voltage is applied to the right electrode 822. As a result, all negatively charged particles 811 move to the left hand side, while all positively charged particles 812 move to the right hand side, leaving a gap without reflective particles between them. This allows a part of the emitted backlight 851 to pass the encased liquid 810 and to contribute to a presentation. The area 860 of the display 800, which can now be traversed by backlight as well, is pointed out by hatching. A portion of the ambient light 850 entering the display 800, in turn, is not reflected anymore by the particles 811, 812, but passes through the gap and does thus not contribute to the presentation.

Moving charged particles with a reflective surface by means of an electrical field can thus be used to adjust the reflectance-transmittance ratio of the reflector.

It is to be understood that reflectors with adjustable reflection capabilities can be realized in various other ways as well. One further example is a reflector comprising a polymer nematic liquid crystal (PNLC) material, which may be diffusive-reflective in a driven mode, in which a voltage is applied, and fully transparent in a non-driven mode, in which no voltage is applied.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. An apparatus comprising:
an arrangement of display pixels; and
electrically controllable reflectors arranged to reflect ambient light passing through said display pixels.

2. The apparatus according to claim 1, wherein said reflectors are electrically controllable in that they comprise an effective reflective area, the size of which is electrically controllable.

3. The apparatus according to claim 1, wherein said reflectors comprise an electrically controllable reflection capability.

4. The apparatus according to claim 1, wherein said reflectors comprise electrically controllable mirrors.

5. The apparatus according to claim 1, wherein said reflectors comprise an electrically controllable liquid.

6. The apparatus according to claim 1, wherein said reflectors comprise an electrically controllable substrate.

7. The apparatus according to claim 1, further comprising color filters arranged to color filter light passing through said display pixels.

8. The apparatus according to claim 1, further comprising a control component configured to electrically control said reflectors.

9. The apparatus according to claim 8, further comprising an evaluation component arranged to receive from a light sensor an indication of an intensity of ambient light, wherein said evaluation component is configured to cause said control component to electrically control said reflectors depending on said indication of an intensity of ambient light.

10. The apparatus according to claim 8, further comprising an evaluation component arranged to receive information on a user input, wherein said evaluation component is configured to cause said control component to electrically control said reflectors depending on said information on a user input.

11. The apparatus according to claim 1, further comprising a light sensor arranged to detect an intensity of ambient light.

12. The apparatus according to claim 1, further comprising a backlight source, said backlight source being configured to provide a backlight for transmission in direction of said display pixels.

13. The apparatus according to claim 12, wherein said backlight source is electrically controllable.

14. An electronic device comprising:
an apparatus according to claim 1; and
a user interface.

15. A method comprising:
determining a required adjustment of electrically controllable reflectors, which reflectors are arranged to reflect ambient light passing through display pixels; and
controlling said reflectors accordingly.

16. The method according to claim 15, wherein determining a required adjustment comprises determining a required adjustment of an effective reflective area of said reflectors.

17. The method according to claim 15, wherein determining a required adjustment comprises determining a required adjustment of a reflection capability of said reflectors.

18. The method according to claim 15, wherein controlling said reflectors comprises on of:
controlling electrically controllable mirrors forming a part of said reflectors;
controlling an electrically controllable liquid forming a part of said reflectors;
controlling an electrically controllable substrate forming a part of said reflectors.

19. The method according to claim 15, further comprising receiving an indication of an intensity of ambient light, wherein a required adjustment of said reflectors is determined depending on said indication of an intensity of ambient light.

20. The method according to claim 15, further comprising receiving information on a user input, wherein a required adjustment of said reflectors is determined depending on said information on a user input.

21. The method according to claim 15, further comprising measuring an intensity of ambient light.

22. The method according to claim 15, further comprising:
determining a required amount of backlight, said backlight being provided by an electrically controllable backlight source for transmission in direction of said display pixels; and
controlling said backlight source according to said required amount of backlight.

23. A computer program product in which a program code is stored in a computer readable medium, said program code realizing the following when executed by a processor:
determining a required adjustment of electrically controllable reflectors, which reflectors are arranged to reflect ambient light passing through display pixels; and
causing a corresponding control of said reflectors.

24. The computer program product according to claim 23, wherein determining a required adjustment comprises determining a required adjustment of an effective reflective area of said reflectors.

25. The computer program product according to claim 23, wherein determining a required adjustment comprises determining a required adjustment of a reflection capability of said reflectors.

26. The computer program product according to claim 23, wherein causing said control of said reflectors comprises one of:
causing a control of electrically controllable mirrors forming a part of said reflectors;
causing a control of an electrically controllable liquid forming a part of said reflectors;
causing a control of an electrically controllable substrate forming a part of said reflectors.

27. The computer program product according to claim 23, further comprising receiving an indication of an intensity of ambient light, wherein a required adjustment of said reflectors is determined depending on said indication of an intensity of ambient light.

28. The computer program product according to claim 23, further comprising receiving information on a user input, wherein a required adjustment of said reflectors is determined depending on said information on a user input.

29. The computer program product according to claim 23, further comprising:
determining a required amount of backlight, said backlight being provided by an electrically controllable backlight source for transmission in direction of said display pixels; and
causing said backlight source to be controlled according to said required amount of backlight.

30. An apparatus comprising:
first means for allowing a controllable amount of light passing through them; and
second means for reflecting ambient light passing through said first means, wherein said second means are electrically controllable.

31. The apparatus according to claim 30, further comprising:
third means for determining a required adjustment of said second means; and
fourth means for controlling said second means accordingly.

32. The apparatus according to claim 30, further comprising:
fifth means for providing a backlight for transmission in direction of said first means.
